(19) United States
(12) Patent Application Publication
(10) Pub. No.: US 2026/0222225 A1
(43) Pub. Date: Jul. 30, 2026

(54) SYSTEM AND METHOD FOR PRIVACY PRESERVING DIGITAL SIGNATURE WITH HASHING AND SIGNING OPERATIONS PERFORMED IN DISTRIBUTED TRUSTED RICH EXECUTION ENVIRONMENTS

(71) Applicants: John Kar-Kin ZAO, Toronto (CA); FiduciaEdge Technologies Co., Ltd., Hsinchu City (TW); TAIWAN-CA INC., Taipei City (TW)

(72) Inventors: John Kar-Kin ZAO, Toronto (CA); Chya-Hung TSAI, Taipei City (TW); Hung-Yi Tony TU, Taipei City (TW); Tz-Ching YANG, Hsinchu City (TW)

(21) Appl. No.: 19/144,518

(22) PCT Filed: Dec. 29, 2023
(86) PCT No.: PCT/IB2023/063389

§ 371 Date: Jun. 30, 2025

Related U.S. Application Data
(60) Provisional application No. 63/477,826, filed on Dec. 30, 2022.

(51) Int. Cl. H04L 9/32; G06F 21/64; H04L 9/08

(52) U.S. Cl. CPC H04L 9/3247; G06F 21/64; H04L 9/0825; H04L 9/3236; H04L 9/3263

(57) ABSTRACT

A distributed trusted computing system consisted of a cluster of Trusted Rich Execution Environments (T-REEs) instantiated on a network of computers, and the information processing methods performed within these T-REEs, and the information interchange methods employed by these T-REEs to communicate with one another to perform a privacy-preserving digital signature operation on electronic files are disclosed. This disclosure enables a trusted party, referred to as the Certification Authority (a.k.a. the signer), to certify the content integrity and the origin authenticity of a file submitted by the file owner (referred to as the customer) by performing a hashing operation on the file in the T-REE instantiated on the customer computers and a private key signing operation on a hash value in the T-REE instantiated on the signer computer. It enables the certification authority to certify the integrity and authenticity of the file without accessing the content thereof.

### BACKGROUND

### Field of Invention

This disclosure relates in general to the practice of affixing digital signature to an electronic file (a.k.a. File Signing) in order to certify content integrity and origin authenticity of that file. In particular, this disclosure discloses the architecture of a distributed trusted computing system including virtualized trusted execution environments instantiated in a network of computers and the information processing and interchanging methods employed by these virtualized trusted execution environments to perform a digital signature operation on an electronic file while preserving the content privacy of that file.

### Description of Related Art

In the ecosystems of Internet of Things (IoT), Software Defined Networks (SDN), and Edge/Cloud Computing Systems, system and application software modules are often supplied by different software developers, each of which intends to preserve the proprietary ownership of their software while allowing their software to be integrated with those of the other developers and then deployed together through the Continuous Integration and Continuous Deployment (CI-CD) process in a Secure Development-Operation (DevSecOps) lifecycle. All the system and application software modules developed by the software developers in this lifecycle must be certified by trusted Certification Authorities (CA) before they can be deployed and run on the user systems. For instances, system software must be certified before they can be included in a secure boot process while containerized application software must be notarized before they can be included in an on-line provisioning process. However, the software is sent to the CA, so the content of the software may be leaked.

### SUMMARY

Embodiments of the present disclosure provide a distributed digital signature system including a customer subsystem and a signer subsystem. The customer subsystem has a rich execution environment, a first trusted rich execution environment, a second trusted rich execution environment and a first trusted execution environment. The signer subsystem has a third trusted rich execution environment and a second trusted execution environment. The customer subsystem is configured to provide a file and call a signature request function with respect to the file in the rich execution environment. The customer subsystem is configured to call a hash request function with respect to the file in the first trusted rich execution environment, and compute a hash of the file in the first trusted execution environment in response to the hash request function. The customer subsystem is configured to generate a first signature of the hash. The customer subsystem is configured to establish, in the first trusted rich execution environment, an atomic and secure transaction with the signer subsystem. The atomic and secure transaction includes: transmitting, by the customer subsystem in the first trusted rich execution environment, the hash and the first signature to the signer subsystem; verifying, by the signer subsystem in the second trusted execution environment, the first signature; generating, by the signer subsystem in the second trusted execution environment, a second signature with respect to the hash after a successful verification of the first signature; and transmitting, by the signer subsystem in the third trusted rich execution environment, the second signature to the customer subsystem. The customer subsystem is configured to generate, in the second trusted rich execution environment, a file blob according to the second signature of the hash and the file in response to the signature request function.

In some embodiments, a file signing client module is installed in the first trusted rich execution environment, a file blob builder module is installed in the second trusted rich execution environment, and a file signing server module is installed in the third trusted rich execution environment.

In some embodiments, the atomic and secure transaction further includes: performing, by the file signing client module and the file signing server module, a mutual authentication; and exchanging, by the file signing client module and the file signing server module, a session key.

In some embodiments, the atomic and secure transaction further includes: transmitting, by the file signing server module to the file signing client module, a customer certificate issued to the customer subsystem.

In some embodiments, the first signature of the hash is generated according to a private key issued to the file signing client module.

In some embodiments, the second signature of the hash is computed according to a private key corresponding to a customer.

In some embodiments, the file signing client module, the file signing server module, the file blob builder module, the hash function, and the signature function are notarized.

In some embodiments, the customer subsystem includes a common hardware, a dedicated hardware, and a protected hardware. The common hardware is disposed in the rich execution environment, the dedicated hardware is disposed in the first and the second trusted rich execution environments, and the protected hardware is disposed in the first trusted execution environment.

In some embodiments, an untrusted general-purpose operating system is executed in the rich execution environment, a trusted general-purpose operating system is executed in the first and the second trusted rich execution environments, and a trusted special-purpose operating system is executed in the first trusted execution environment.

In some embodiments, only the file signing server module in the signer subsystem communicates with the file signing client module in the customer subsystem.

In some embodiments, the file is not provided for the signer subsystem.

From another aspect, embodiments of the present disclosure provide a distributed digital signature method including: providing, by a customer subsystem in a rich execution environment, a file and calling a signature request function with respect to the file; calling, by the customer subsystem in a first trusted rich execution environment, a hash request function with respect to the file; computing, by the customer subsystem in a first trusted execution environment, a hash of the file in response to the hash request function; generating, by the customer subsystem in the first trusted execution environment, a first signature of the hash; establishing, by the customer subsystem and a signer subsystem, an atomic and secure transaction. The atomic and secure transaction includes: transmitting, by the customer subsystem, the hash and the first signature to the signer subsystem; verifying, by the signer subsystem in a second trusted execution environment, the first signature; generating, by the signer subsystem in the second trusted execution environment, a second signature of the hash after a successful verification of the first signature; and transmitting, by the signer subsystem in a third trusted rich execution environment, the second signature to the customer subsystem. The distributed digital signature method also includes: generating, by the customer subsystem in a second trusted rich execution environment, a file blob according to the second signature of the hash and the file in response to the signature request function.

### BRIEF DESCRIPTION OF THE DRAWINGS

The disclosure can be more fully understood by reading the following detailed description of the embodiment, with reference made to the accompanying drawings as follows.

FIG. 1 is a diagram illustrating the architecture of a customer subsystem and a signer subsystem in accordance with an embodiment. The solid arrows in the figure denote the secure communications among the REE, the T-REE and the TEE. The dashed arrow in the figure shows the interactions between the TEE and the Trusted Key and Certificate Management system to generate the private and public key pairs used by the REE, the T-REE and the TEE for secure communications.

FIG. 2 is a diagram illustrating the functional block diagram of the distributed digital signature system in accordance with an embodiment. In the figure, the functional block included in a rounded rectangle is provided by the customer and assumed to be untrustworthy while the functional blocks included in the sharp rectangles are provided by the Certification Authority (CA) or other trusted parties. The software modules of these functional blocks are certified for their integrity and origin authenticity. All communications among the functional blocks (shown in solid arrows) are protected by cryptographically strong data confidentiality and integrity services, as well as mutual authentication between the communication endpoints.

FIG. 3 is a diagram illustrating the sequence diagram of operations between two subsystems in accordance with an embodiment.

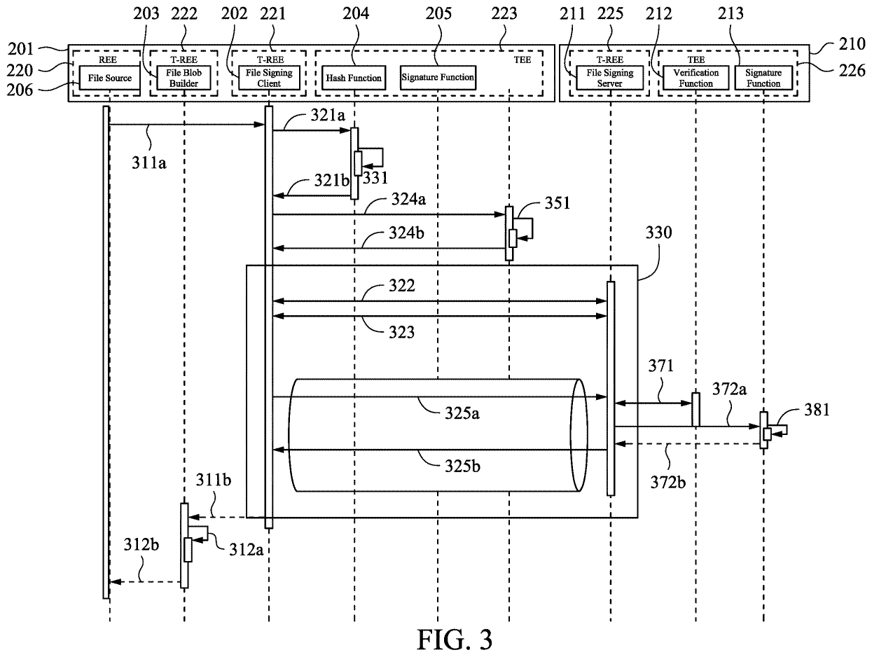

FIG. 4 is a diagram illustrating the flowchart of a distributed digital signature method in accordance with an embodiment.

### DETAILED DESCRIPTION

Specific embodiments of the present invention are further described in detail below with reference to the accompanying drawings, however, the embodiments described are not intended to limit the present invention and it is not intended for the description of operation to limit the order of implementation. Moreover, any device with equivalent functions that is produced from a structure formed by a recombination of elements shall fall within the scope of the present invention. Additionally, the drawings are only illustrative and are not drawn to actual size.

The using of “first”, “second”, “third”, etc. in the specification should be understood for identifying units or data described by the same terminology, but are not referred to particular order or sequence.

Content integrity and origin authenticity of an electronic file can be certified with a digital signature of that file, which is generated by first calculating a digital hash value of the content of the file and then performing a private key signing operation on the digital hash value using the privacy key issued by a Certification Authority to the file owner. Traditionally, the digital hashing and private key signing operations are performed together in a secure computing environment known as a Trusted Execution Environment (TEE) managed by the Certification Authority or its proxy. In order to perform this operation, the file owner needs to submit the electronic file to the Certification Authority. The content of the electronic file is thus disclosed to the Certification Authority or its proxy.

In order to preserve the information privacy of the electronic file, the content and the sensitive meta-data of the file must not be disclosed to any other parties, not even to the Certification Authority. To achieve this goal, the file owner (instead of the Certification Authority) should compute the hash value of the file in a trustworthy manner and then transport the hash value (not the file itself) through a secure communication channel to the Certification Authority. After authenticating the origin of the hash value, the Certification Authority computes the digital signature of the hash value using the private key assigned to the file owner. This Distributed File Hashing and File Signing Operation thus separates the calculation of the hash value of the file, which requires the proprietary file as input, from the computing of the digital signature of the file, which requires only the hash value of the file as input. By performing these two operations in separate Trusted Rich Execution Environments (T-REEs), each of which provides information isolation protection, the content privacy of the proprietary file is thus preserved.

This Distributed File Hashing and Signing Operation can be used to certify content integrity and origin authenticity of any electronic file including electronic documents, program codes, AI models and data sets. Specifically, digital signing of program codes and AI models has become a necessary step in a Secure Development-Operation (DevSecOps) lifecycle. All system and application software modules developed by software developers in this lifecycle must be certified by trusted Certification Authorities before they can be deployed and run on user systems.

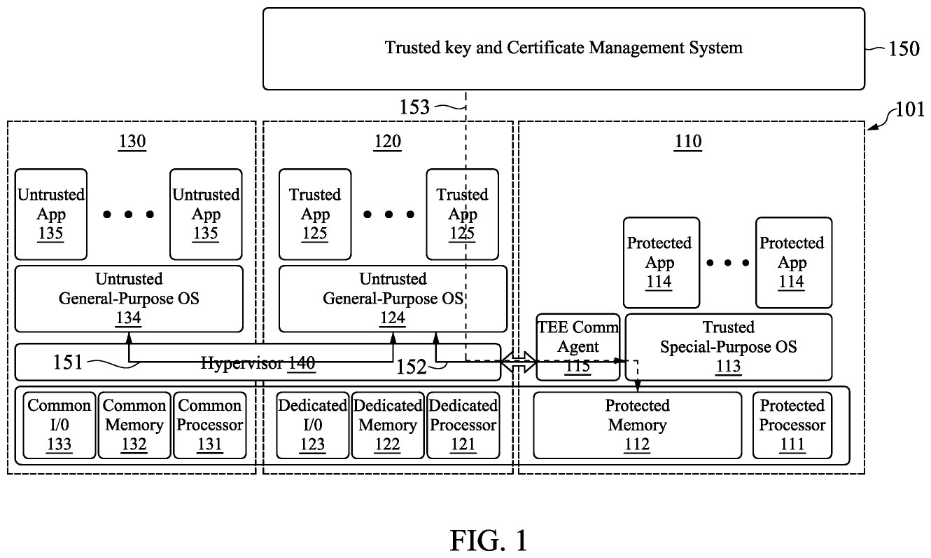

The Distributed Trusted Computing System disclosed in the filed utility patents specifies a system architecture illustrated in FIG. 1. A distributed digital signature system 100 includes a customer subsystem 101. The customer subsystem 101 has one or more rich execution environments (REE) 130, multiple trusted rich execution environments (T-REE) 120, and one or more rich execution environment (TEE) 110. The REEs 130 are unprotected virtual execution environment instantiated over a hypervisor 140 on a computer to run unprotected and untrusted general-purpose applications 135 under the control of a untrusted general-purpose operation system 134. Common hardware (undedicated) including common processors 131, memory 132, and input/output I/O 133 are disposed in the REE 130 to execute the untrusted general-purpose operation system 134 and the untrusted general-purpose application programs 135.

The T-REEs 120 are protected virtual execution environments instantiated over the hypervisor 140 on the computer to run trusted general-purpose application 125. These trusted general-purpose applications 125 must have their code integrity and origin authenticity verified by a trusted third party and signed by a Certification Authority (CA) before it can be deployed and run in the T-REEs 120. Dedicated hardware including dedicated processors 121, memory 122, and I/O 123 are disposed in the T-REEs 120 to execute the trusted general-purpose application programs 125 under the control of a trusted general-purpose operating system 124 dedicated to serve the T-REEs 120. These dedicated processors 123, memory 122 and I/O 121 are assigned to specific T-REEs through the computer hardware that enforces resource separation among the execution environments.

The TEEs 110 are protected physical or virtual execution environments established in a protected section of the computer. Protected hardware including protected processors 111 and protected memory 112 is disposed in the TEEs 110 that cannot be accessed or used by other execution environments. The protected hardware is used to enforce resource separation between one TEE 110 and the other execution environments including other TEEs, T-REEs 120 and REEs 130. Instead of going through the hypervisor 140, the TEE 110 exchanges information with other execution environments through a TEE communication agent 115 running in a privileged computing level separated TEE communications from other system and user computing tasks. The TEEs 110 run protected special-purpose applications 114 under the control of a trusted special-purpose operation system 113 to perform critical operations such as cryptographic operations and trusted system clocks.

A communication 152 among the T-REEs 120 is protected by end-to-end data confidentiality and integrity services as well as mutual authentication of the communication endpoints. A communication 151 between the REE 130 and T-REE 120 is protected by end-to-end data confidentiality and integrity services as well as mutual authentication of the communication endpoints. The security services protecting these communications are performed by the protected special-purpose application 114 running in the TEEs 110. The certificates and cryptographic keys used for the protection are stored in the protected memory 112 in the TEEs 110 and managed by one of the protected special-purpose application programs 114 running in the same TEE 110.

The cryptographic keys and certificates used to protect all the aforementioned communications are issued and managed by a trusted key and certificate management system 150. The keys and the certificates are stored in the protected memory 112 through a communication 153.

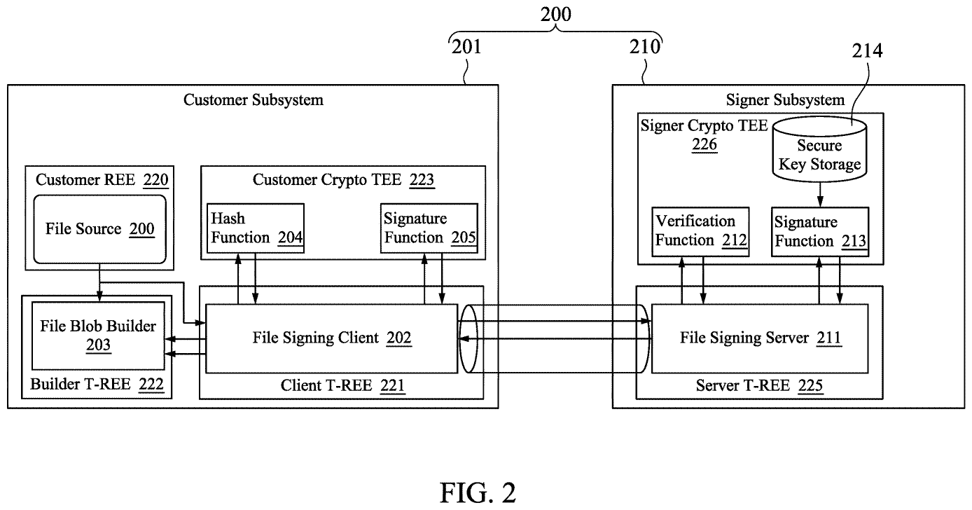

Referring to FIG. 2, a distributed digital signature system 200 includes a customer subsystem 201 and a signer subsystem 210. The customer subsystem 201 includes a REE 220, a T-REE 221, a T-REE 222, and a TEE 223, and the structure of which is identical to that of FIG. 1. For example, the REE 220 is one of the REE 110; the T-REE 221 and the T-REE 222 are two of the T-REEs 120; the TEE 223 is one of the TEE 110. The REE 220, T-REE 221, T-REE 222, and TEE 223 are established in the premise of a file source (a.k.a. the customer).-The REE 220 is also referred to as a developer REE. The T-REE 221 is also referred to as a client T-REE. The T-REE 222 is also referred to as a builder T-REE. The TEE 223 is also referred to as a customer crypto TEE.

The customer subsystem 201 computes a hash of a file and then builds a file blob of the file by combining the file and a file signature of the file. The file may be a program code or any digital files which are not limited in the disclosure.

To be specific, the signer subsystem 210 executes a file source 206 installed in the REE 220, a file signing client module 202 installed in the T-REE 221, a file blob builder module 203 installed in the T-REE 222, a signature function 205 and a hash function 204 installed in the TEE 223. The operation of each module will be described in detail below.

The signer subsystem 210 has a T-REE 225 and a TEE 226. The T-REE 225 is also referred to as a server T-REE. The TEE 226 is also referred to as a signer crypto TEE 226. The T-REE 225 and the TEE 226 are established in the premise of the Certification Authority (CA). The signer subsystem 210 computes a file signature from the hash after verifying its authenticity using a private key assigned to the file signing client module 202. To be specific, the signer subsystem 210 executes a file signing server module 211 installed in the T-REE 225, and a verification function 212 and a signature function 213 installed in the TEE 226. A secure key storage 214 is also installed in the TEE 226.

In terms of the operational and trust relations among the functional modules, the distributed hashing and signing system can be decomposed into two domains of trust (DoT). The first domain is referred to as file source and file blob Building Domain consists of the file source 206 in the REE 220 and the file blob builder module 203 in the T-REE 222. The operation of the modules in the first domain is under the control of the software developer (i.e. customer) and is separated from the operation of the second domain.

The second domain is referred to as File Hashing and Signing Domain including the file signing client module 202, the hash function 204, the signature function 205, the file signing server module 211, the verification function 212 and the signature function 213. The operation of the modules in the second domain is under the control of the Certification Authority (CA) and is separated from the operation of the first domain. The second domain is a trusted domain. All the programs used to implement these modules are verified by a trusted third party and certified by an accredited certification authority before they can be deployed and used in this domain. In the second domain, the file signing client module 202 computes the hash based on the file while the file signing server module 211 computes the file signature based on the verified file hash separately. Both the file signing client module 202 and the file signing server module 211 use the cryptographic functions installed in the crypto TEE 223 or 226 they belong to.

Following paragraphs specify the functions and the interactions among the components illustrated in FIG. 2.

### File Source

In some embodiments, the file source 206 residing in the REE 220 is the operation environment of the software developer (i.e. customer) for providing a code image. In other embodiments, the file source 206 may be any suitable software module for providing any digital file used below. In order for the other modules of the system to trust the content integrity and the origin authenticity of their interactions with the file source 206, all the communications with this component are protected by end-to-end data confidentiality and integrity services as well as mutual authentication of the communication endpoints.

### File Signing Client Module

In some embodiments, the file signing client module 202 is the only module in the second trusted domain that the file source 206 and the file blob builder module 203 will interact with. It receives the file from the file source 206 and performs the file hash computing operation to generate a file hash by calling the hash function 204 in the TEE 223. It also generates a client signed file hash from the file hash using a private key assigned by the CA to the file signing client module 202 by calling the signature function 205 in the TEE 223.

The file signing client module 202 is also the only module that can interact with the file signing server module 211 in the signer subsystem 210. This interaction would go through an atomic and secure transaction. Through that transaction, the file signing client module 202 receives the file signature of the file and a customer certificate that can be used to verify the file signature from the file signing server module 211. The file signing client module 202 then forwards these entities to the file blob builder module 203 so that they can be combined with a file to generate a file blob.

### File Signing Server Module

In some embodiments, the file signing server module 211 is the only module that can interact with the file signing client module 202 in the customer subsystem 200. It receives the file hash from the file signing client module 202 and verifies the integrity and authenticity of the file hash using the public key certificate issued to the file signing client module 202 by calling the verification function 212 in the TEE 226.

After a successful verification, the file signing server module 211 performs the file signature computing operation by calling the signature function 213 in the TEE 226. The signature function 213 then fetches the private key that was assigned to the customer (known as the signature key) from the secure key storage 214 and uses that signature Key to sign the verified file hash.

After completing the file signature computing operation, the file signing server module 211 then sends the signature of the file, the public key certificate corresponding to the private key assigned to the customer (known as the customer certificate) to the file signing client module 202 through the atomic and secure transaction.

### File Blob Builder Module

The file blob builder module 203 is the component in the customer subsystem 200 that combines the file with its signature and the customer certificate to build file blobs in different formats so that they can be deployed, verified, and used by various user systems. The file blob builder module 203 is a component verified and certified by trusted third parties as it needs to be trusted by different user systems to generate unaltered and correct file blobs. The communications between the file blob builder module 203 and the file signing client module 202 is protected by end-to-end data confidentiality and integrity services as well as mutual authentication of the communication endpoints.

### Service Workflow for Privacy-Preserving Distributed Signing

The workflows of the distributed digital signature method are shown in FIG. 2 in the form of a sequence diagram. Following are the four operations embedded in the sequence diagram.

### File Signing Operation

An operation 311a is initiated by a signature request function call from the file source 206 to the file signing client module 202 with a file as an argument. In other words, the customer subsystem 200 provides the file and calls the signature request function with respect to the file in the REE 220. This function call initiates the distributed file hashing and file signing process and ends with a return of the signed file blob from the file blob builder module 203.

### File Hash Computing Operation

In response to the signature request function, the file signing client module 202 performs two operations 321a and 324a. In the operation 321a, it calls a hash request function with respect to the file in the T-REE 221. In an operation 331, a hash of the file is computed by the hash function 204 in the TEE 223 in response to the hash request function. In an operation 321b, the hash request function returns the hash of the file (also referred to as the file hash) to the file signing client module 202.

In the operation 324a, the file signing client module 202 initiates a sign hash function call with the file hash as an argument to the signature function 205 in the TEE 223. In an operation 351, a first signature of the file hash is generated using the private key assigned to the file signing client module 202 by the signer subsystem 210. In an operation 324b, the sign hash function call returns the first signature to the file signing client module 202.

### Atomic and Secure Transaction

Next, an atomic and secure transaction 330 is established by the file signing client module 202 and the file signing server module 211. The atomic and secure transaction 330 ensure (a): content confidentiality of the messages exchanged in the transaction; (b): content integrity of the messages exchanged in the transaction; (c) the transaction can only finish in a successful completion state; otherwise, the transaction will be rolled back to its initial state before it was started. In other words, the entire transaction is thus conducted as an indivisible atomic transaction, which ensures either all the actions will be complete successfully or no action will occur at all.

In an operation 322, a mutual authentication is performed by the file signing client module 202 and the file signing server module 211. In an operation 323, a session key is exchanged between the file signing client module 202 and the file signing server module 211. The Transport Layer Security (TLS) or Secure Sockets Layer (SSL) protocol may be adopted, and the detail of the protocol will not be elaborated herein.

In an operation 325a, the file signing client module 202 transmits the file hash and the first signature to the file signing server module 211. In an operation 371, the file signing server module 211 initiates a verification function call with the file hash and the first signature as arguments. The first signature of the file hash is verified by the verification function 212 using the public key corresponding to the private key assigned to the file signing client module 202. After a successful verification, in an operation 372a, the file signing server module 211 initiates a file signature function call with the verified file hash as an argument. In an operation 381, a second signature (also referred to as a file signature) of the file hash is then computed by the signature function 213 using the private key assigned to the customer by the signer subsystem 210. In an operation 372b, the file signature function call returns the second signature to the file signing server module 211. In an operation 325b, the second signature and the public key certificate corresponding to the customer private key (referred to as the customer certificate) are then sent back to the file signing client module 202.

### File Blob Building Operation

After receiving the file signature and the customer certificate, in an operation 311b, the file signing client module 202 forwards them to the file blob builder module 203. The file blob builder module 203 then sends a return variable of success to the file source 206. The file source 206 then initiates a build file blob function call to the file blob builder module 203 with the file as an argument. In an operation 312a, the file blob builder module 203 then combined the file with the file signature and the customer certificate to generate a file blob in different formats to meet the requirements of different user systems. In an operation 312b, the file blob builder module 203 returns the file blob to the file source 206 in response to the signature request function which is initiated in the operation 311a.

Like the communication between the file signing client module 203 and the file blob builder module 203, the communication between the file source 206 and file blob builder module 203 is also protected by end-to-end data confidentiality and integrity services as well as mutual authentication of the communication endpoints.

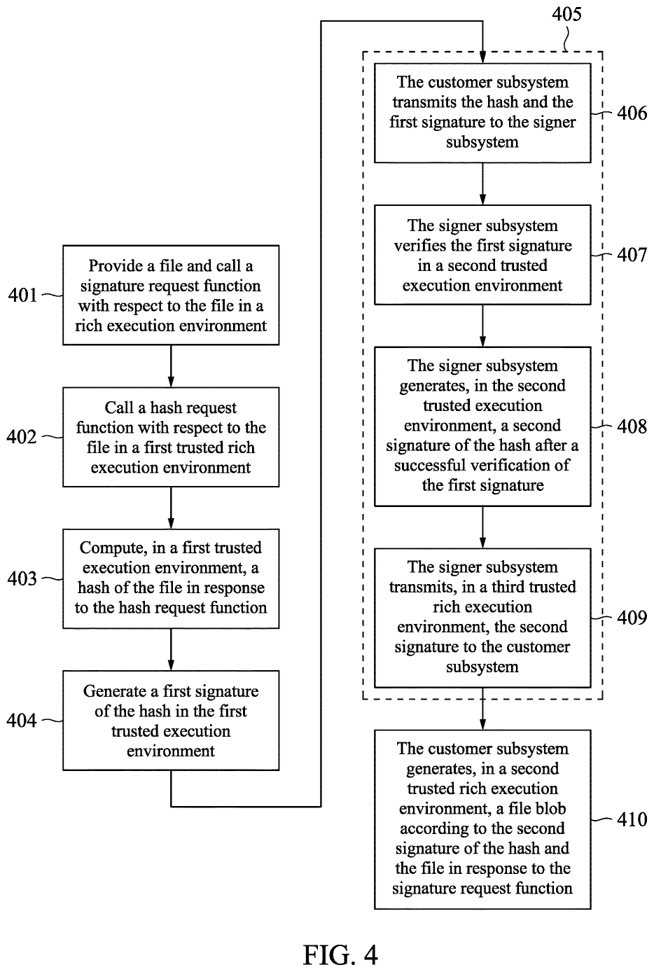

FIG. 4 is a diagram illustrating a distributed digital signature method in accordance with an embodiment. Referring to FIG. 4, in a step 401, a customer subsystem provides a file and calls a signature request function with respect to the file in a rich execution environment. In a step 402, the customer subsystem calls a hash request function with respect to the file in a first trusted rich execution environment. In a step 403, the customer subsystem computes, in a first trusted execution environment, a hash of the file in response to the hash request function. In a step 404, the customer subsystem generates a first signature of the hash in the first trusted execution environment. Next, the customer subsystem and a signer subsystem establish an atomic and secure transaction 405 which comprises steps 406-409. In the step 406, the customer subsystem transmits the hash and the first signature to the signer subsystem. In the step 407, the signer subsystem verifies the first signature in a second trusted execution environment. In the step 408, the signer subsystem generates, in the second trusted execution environment, a second signature of the hash after a successful verification of the first signature. In the step 409, the signer subsystem transmits, in a third trusted rich execution environment, the second signature to the customer subsystem. In the step 410, the customer subsystem generates, in a second trusted rich execution environment, a file blob according to the second signature of the hash and the file in response to the signature request function.

In the aforementioned system and process, the customer's file is not provided to the signer subsystem 210. Instead, the hash value of the file is given to the signer subsystem 210. The customer can still obtain the digital signature,—thereby protecting the privacy of the customer's file.

In some embodiments, the distributed digital signature system 100 is realized as a distributed cloud native computing system implemented according to the guidelines established by Cloud Native Computing Foundation (CNCF) under the conglomerate of Linux Foundation. The distributed cloud native computing system is established to run containerized software modules known as applications in separated REEs 130 or T-REEs 120 known as container runtime environments under the control of the Kubernetes distributed container orchestration system. In some embodiments, the applications running in the REEs do not need to be certified by a trusted third party such as a certification authority (CA) of their authenticity and integrity. Thus, they are regarded as untrusted applications 135.

In some embodiments, the applications running in the T-REEs are certified by a trusted third party such as a Certification Authority (CA) of their authenticity and integrity. Thus, they are regarded as trusted applications 125.

In some embodiments, the container runtime environments can be run in virtual machines (VMs) established upon the hypervisors 140 deployed on individual computers in this distributed cloud native computing system. In this case, the general-purpose operating system (OS) that runs in a REE does not need to be certified by a trusted third party of its authenticity and integrity. Thus, it is regarded as an untrusted general-purpose OS 134.

In the case that a VM is used, the general-purpose operating system (OS) that runs in the T-REE is certified by a trusted third party of its authenticity and integrity. Thus, it is regarded as a trusted general-purpose OS 124. Both trusted and untrusted general-purpose OS can be developed based on Linux operating system, on which Kubernetes and the container runtime environments are established.

In some embodiments, the assignments of dedicated processor 121, dedicated memory 122, and dedicated I/O 123 are performed by hardware-assisted functions provided by the IC manufacturers. Examples of these functions include TrustZone™ (TZ) and Confidential Computing Architecture ™ (CCA) of ARM; Software Guard Extension™ (SGX) and Trusted Domain Extension™ (TDX) of Intel; Secure Encrypted Virtualization™ (SEV) of AMD.

In some embodiments, the TEE 110 is established as a protected computing environment implemented on the protected processor 111 and the protected memory 112. Examples of protected processor include Trusted Platform Modules (TPM) specified by the Trusted Computing Group (TCG) and the CPU secure mode under TrustZone™ (TZ) developed by ARM®. Protected memory is those segments in the physical memory of the computer that can only be accessed by the protected processor and its associated co-processors.

In a TEE, a trusted special-purpose OS 113 is used to run the protected applications 114 on the protected processor 111 and its associated co-processors in the protected memory 112. An example of the trusted special-purpose OS is the OP-TEE Trusted OS. The trusted special-purpose OS supports only the execution of a single task at a time; no concurrent execution is allowed. The purpose of this limitation is to eliminate the possibility of information leakage through concurrent execution.

In some embodiments, only the protected applications 114 performing security functions are executed in a TEE. Examples of these applications include symmetric and asymmetric encryption and decryption, random number generation and trusted system clocks.

Although the present invention has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A distributed digital signature system comprising:
a customer subsystem having a rich execution environment, a first trusted rich execution environment, a second trusted rich execution environment and a first trusted execution environment; and
a signer subsystem having a third trusted rich execution environment and a second trusted execution environment,
wherein the customer subsystem is configured to provide a file and call a signature request function with respect to the file in the rich execution environment,
wherein the customer subsystem is configured to call a hash request function with respect to the file in the first trusted rich execution environment, and compute a hash of the file in the first trusted execution environment in response to the hash request function,
wherein the customer subsystem is configured to generate a first signature of the hash,
wherein the customer subsystem is configured to establish, in the first trusted rich execution environment, an atomic and secure transaction with the signer subsystem, and the atomic and secure transaction comprises:
transmitting, by the customer subsystem in the first trusted rich execution environment, the hash and the first signature to the signer subsystem;
verifying, by the signer subsystem in the second trusted execution environment, the first signature;
generating, by the signer subsystem in the second trusted execution environment, a second signature with respect to the hash after a successful verification of the first signature; and
transmitting, by the signer subsystem in the third trusted rich execution environment, the second signature to the customer subsystem,
wherein the customer subsystem is configured to generate, in the second trusted rich execution environment, a file blob according to the second signature of the hash and the file in response to the signature request function.

2. The distributed digital signature system of claim 1, wherein a file signing client module is installed in the first trusted rich execution environment, a file blob builder module is installed in the second trusted rich execution environment, a file signing server module is installed in the third trusted rich execution environment.

3. The distributed digital signature system of claim 2, wherein the atomic and secure transaction further comprises:
performing, by the file signing client module and the file signing server module, a mutual authentication; and
exchanging, by the file signing client module and the file signing server module, a session key.

4. The distributed digital signature system of claim 3, wherein the atomic and secure transaction further comprises:
transmitting, by the file signing server module to the file signing client module, a customer certificate issued to the customer subsystem.

5. The distributed digital signature system of claim 4, wherein the first signature of the hash is generated according to a private key issued to the file signing client module.

6. The distributed digital signature system of claim 5, wherein the second signature of the hash is computed according to a private key corresponding to a customer.

7. The distributed digital signature system of claim 6, wherein the file signing client module, the file signing server module, the file blob builder module, the hash function, and the signature function are notarized.

8. The distributed digital signature system of claim 1, wherein the customer subsystem comprises a common hardware, a dedicated hardware, and a protected hardware,
wherein the common hardware is disposed in the rich execution environment, the dedicated hardware is disposed in the first and the second trusted rich execution environments, and the protected hardware is disposed in the first trusted execution environment.

9. The distributed digital signature system of claim 8, wherein an untrusted general-purpose operating system is executed in the rich execution environment, a trusted general-purpose operating system is executed in the first and the second trusted rich execution environments, and a trusted special-purpose operating system is executed in the first trusted execution environment.

10. The distributed digital signature system of claim 2, wherein only the file signing server module in the signer subsystem communicates with the file signing client module in the customer subsystem.

11. The distributed digital signature system of claim 1, wherein the file is not provided for the signer subsystem.

12. A distributed digital signature method comprising:
providing, by a customer subsystem in a rich execution environment, a file and calling a signature request function with respect to the file;
calling, by the customer subsystem in a first trusted rich execution environment, a hash request function with respect to the file;
computing, by the customer subsystem in a first trusted execution environment, a hash of the file in response to the hash request function;
generating, by the customer subsystem in the first trusted execution environment, a first signature of the hash;
establishing, by the customer subsystem and a signer subsystem, an atomic and secure transaction which comprises:
transmitting, by the customer subsystem, the hash and the first signature to the signer subsystem; and
verifying, by the signer subsystem in a second trusted execution environment, the first signature;
generating, by the signer subsystem in the second trusted execution environment, a second signature of the hash after a successful verification of the first signature; and
transmitting, by the signer subsystem in a third trusted rich execution environment, the second signature to the customer subsystem,
generating, by the customer subsystem in a second trusted rich execution environment, a file blob according to the second signature of the hash and the file in response to the signature request function.

13. The distributed digital signature method of claim 12, wherein a file signing client module is installed in the first trusted rich execution environment, a file blob builder module is installed in the second trusted rich execution environment, a file signing server module is installed in the third trusted rich execution environment, wherein the atomic and secure transaction further comprises:
performing, by the file signing client module and the file signing server module, a mutual authentication; and
exchanging, by the file signing client module and the file signing server module, a session key.

14. The distributed digital signature method of claim 13, wherein the atomic and secure transaction further comprises:
transmitting, by the file signing server module to the file signing client module, a customer certificate issued to the customer subsystem.

15. The distributed digital signature method of claim 14, wherein the first signature of the hash is generated according to a private key issued to the file signing client module.

16. The distributed digital signature method of claim 15, wherein the second signature of the hash is computed according to a private key corresponding to a customer.

17. The distributed digital signature method of claim 16, wherein the file signing client module, the file signing server module, the file blob builder module, the hash function, and the signature function are notarized.

18. The distributed digital signature method of claim 12, wherein the file is not provided for the signer subsystem.
